(19) United States
(12) Patent Application Publication
(10) Pub. No.: US 2021/0116703 A1
(43) Pub. Date: Apr. 22, 2021

(54) An optical beam director

(71) Applicant: Baraja Pty Ltd, North Ryde, New South Wales (AU)

(72) Inventors: Cibby PULIKKASERIL, North Sydney (AU); Federico COLLARTE BONDY, Lane Cove (AU); Rebecca LODIN, Sydney (AU); Andrea TABACCHINI, Alexandria (AU)

(21) Appl. No.: 17/254,735

(22) PCT Filed: May 10, 2019
(86) PCT No.: PCT/AU2019/050437

§ 371 Date: Dec. 21, 2020

(30) Foreign Application Priority Data
Jun. 21, 2018 (AU) 2018902217
Aug. 24, 2018 (AU) PCT/AU2018/050901
Dec. 24, 2018 (AU) 2018904943

(51) Int. Cl. G02B 26/10; G01S 17/89; G01S 7/481; G02B 26/08

(52) U.S. Cl. CPC G02B 26/106; G01S 17/89; G01S 7/4817; G02B 26/0808; G01S 7/4818

(57) ABSTRACT

Disclosed herein is a system and method for facilitating estimation of a spatial profile of an environment based on a light detection and ranging (LiDAR) based technique. In one arrangement, the present disclosure facilitates spatial profile estimation based on directing light over one dimension, such as along the vertical direction. In another arrangement, by further directing the one-dimensionally directed light in another dimension, such as along the horizontal direction, the present disclosure facilitates spatial profile estimation based on directing light in two dimensions.

### RELATED APPLICATIONS

The present application is related to Australian patent application 2018902217, filed 21 Jun. 2018, the entire content of which is incorporated herein by reference.

The present application is related to international patent application PCT/AU2018/050961, filed 6 Sep. 2018, the entire content of which is incorporated herein by reference.

### FIELD OF THE DISCLOSURE

The present disclosure generally relates to a system for directing light into multiple directions. More particularly, embodiments of the present disclosure relate to facilitating control of the direction of the light based on its wavelength.

### BACKGROUND

Optical beam direction has several uses, including but not limited to LiDAR (light detection and ranging) applications, in which light is sent into an environment for mapping purposes. In two or three-dimensional mapping, one of the dimensions relates to the range of a point from the origin of the optical beam, whereas the other one or two dimensions relate to a one or two-dimensional space (e.g. in Cartesian (x, y) or polar (r, theta) coordinates) in which the optical beam is steered across.

Reference to any prior art in the specification is not, and should not be taken as, an acknowledgment or any form of suggestion that this prior art forms part of the common general knowledge in any jurisdiction or that this prior art could reasonably be expected to be understood, regarded as relevant and/or combined with other pieces of prior art by a person skilled in the art.

### SUMMARY OF THE DISCLOSURE

An embodiment of an optical beam director includes a first diffractive assembly, arranged to direct an optical beam towards one or more of multiple directions over a first dimension, based on respective one or more selected wavelength channels of the optical beam. The optical beam director includes a second diffractive assembly, including multiple diffractive elements. Each of the multiple diffractive elements are: oriented with its diffraction axis angularly offset from at least one other diffractive element's diffraction axis; and rotatable about a rotational axis perpendicular to the diffraction axis to facilitate directing the optical beam over a second dimension substantially orthogonal to the first dimension.

In some embodiments the multiple diffractive elements are co-rotatable about a common rotational axis.

In some embodiments the multiple diffractive elements are oriented with their diffraction axes maximally angularly offset. The multiple diffractive elements may include two diffractive elements with their diffraction axes angularly offset by 90 degrees from each other. The multiple diffractive elements may include three diffractive elements with their diffraction axes angularly offset by 60 degrees from one another.

In some embodiments the multiple diffractive elements are arranged to, upon rotation of the multiple diffractive elements, sequentially diffract the optical beam beyond a diffraction threshold along the second dimension. The multiple diffractive elements may include periodicity optimised for, upon the rotation of the multiple diffractive elements, maximising the duty cycle of optical beam direction beyond the diffraction threshold along the second dimension. The diffraction threshold may correspond to a non-diffracting condition, or the diffraction threshold may corresponds to a minimum set of metrics, including either or both of (a) a minimum required angular span and (b) a minimum required output optical power or grating transmission.

In some embodiments the periodicity is further designed to increase diffraction efficiency at edge wavelength channels corresponding to limits of angular span along the first dimension.

In some embodiments the first diffractive assembly includes one or more additional diffractive elements being non-rotatable about its (their) optic axis(es) to facilitate directing the optical beam over the first dimension.

In some embodiments, over a field of view across the first and second dimensions, the second diffractive assembly has a duty cycle of at least 80%. In some embodiments the duty cycle is at least 90%. In some embodiments the duty cycle is at least 95%.

An embodiment of a spatial profiling system includes the optical beam director summarised above and/or described herein.

An embodiment of a method includes directing, using a first diffractive assembly, an optical beam towards one or more of multiple directions over a first dimension, based on respective one or more selected wavelength channels of the optical beam and by rotating one or more diffractive elements in a second diffractive assembly, directing the optical beam over a second dimension substantially orthogonal to the first dimension. Diffractive elements in the second diffractive assembly may be oriented with its diffraction axis angularly offset one another. Diffractive elements in the second diffractive assembly may be rotatable about a rotational axis perpendicular to the diffraction axis.

An embodiment of an optical system includes optical components arranged to direct light comprising multiple wavelengths into an environment having a depth dimension over a first dimension and a second dimension, the second dimension substantially perpendicular to the first dimension. The optical components include a first optical subsystem to receive the light, the first optical subsystem comprising a plurality of elements selected from dispersive, diffractive and reflective elements, the plurality of elements arranged in a configuration that directs the received light over the first dimension based on wavelength. The optical component also include a second optical subsystem for receiving the light directed over the first dimension, the second optical subsystem comprising at least one diffractive element, rotatable about a rotational axis perpendicular to its diffraction axis to facilitate directing the optical beam over the second dimension. The optical system includes a receiver for light returned from the environment responsive to light from the optical components, the returned light containing information for determination of the depth dimension over the first dimension and the second dimension.

In some embodiments, each of the plurality of elements in the first optical subsystem are substantially fixed in location and orientation relative to each other.

In some embodiments, the first optical subsystem comprises an angle dependent bandpass filter, wherein one wavelength channel is reflected and another adjacent wavelength channel is passed, creating angular discrimination between the channels. The first optical subsystem may be arranged so that at least a portion of the received light is directed onto the bandpass filter a plurality of times, at different angles corresponding to different pass-bands of the bandpass filter. The arrangement of the first optical subsystem may include a mirror facing the bandpass filter at an orientation other than parallel.

In some embodiments the second optical subsystem includes a plurality of diffractive elements, including a first diffractive element rotatable through a first set of positions that effect diffraction above a threshold related to directing the optical beam over the second dimension, and a second set of positions that do not effect diffraction above the threshold, and a second diffractive element that is oriented within the optical system, at least when the first diffractive element is in a position of the second set of positions, to effect diffraction above the threshold. The optical system may be configured to synchronously rotate the first and second diffractive elements. The optical system may be configured to rotate the first and second diffractive elements about substantially the same axis of rotation.

An embodiment of an optical system for directing light into an environment having a depth dimension over two dimensions, the two dimensions comprising a first dimension and a second dimension substantially perpendicular to the first dimension, includes:
a wavelength router for routing the light from a first port to one of a plurality of second ports based on wavelength, the second ports being arranged to direct the routed light across a wavelength dimension in free space associated with the first dimension of the environment;
a collimating element disposed across the wavelength dimension and arranged to collimate light from the second ports into respective optical beams;

a rotating diffractive element arranged to receive the light from the collimating element and cause direction of the received light across the second dimension of the environment, wherein the direction across the second dimension is based on a rotational position of the rotating dispersive element; and

a receiver for receiving light returned from the environment, the returned light containing information for determination of the depth dimension over the first dimension and the second dimension.

In some embodiments the optical system further includes a wavelength selector for selecting non-neighbouring wavelength channels, wherein the wavelength selector and wavelength router are configured to direct a group of non-neighbouring wavelength channels to each of the plurality of second ports.

In some embodiments the wavelength selector has a free spectral range of no more than 10 GHz, or no more than 5 GHz, or no more than 1 GHz.

In some embodiments the rotating diffractive element has a first diffraction axis and the optical system includes a further rotating diffractive element with a second diffraction axis angularly offset from the first diffraction axis, wherein in combination the rotating diffractive elements have an increased duty cycle for directing light over the second dimension relative to the duty cycle of only one of the diffractive elements.

An embodiment of an optical beam director includes a diffractive element characterised by a two-dimensional pattern on a substrate, the two-dimensional pattern providing the diffractive element with a plurality of angularly offset diffraction axes, wherein the substrate of the diffractive assembly is rotatable about a rotational axis to facilitate directing an optical beam.

In some embodiments the optical beam director includes a plurality of optical beam directors, a first optical beam director that facilitates directing the optical beam over a first dimension and includes the diffractive element characterised by a two-dimensional pattern on a substrate and a second optical beam director arranged to direct the optical beam towards one or more of multiple directions over a second dimension, substantially orthogonal to the first dimension. The second optical beam director may be before or after the diffractive element characterised by a two-dimensional pattern on a substrate.

Further embodiments will become apparent from the following description, given by way of example and with reference to the accompanying drawings.

### BRIEF DESCRIPTION OF THE DRAWINGS

FIG. 1 illustrates an arrangement of a spatial profiling system.

FIG. 2 illustrates an example of a light source used in the spatial profiling system of FIG. 1.

FIG. 3A illustrates a more detailed example of the spatial profiling system in FIG. 1.

FIG. 3B illustrates an example of beam expansion optics in FIG. 3A.

FIG. 4A illustrates a diffractive element illuminated with normally incident light of multiple wavelength channels diffracted into multiple diffraction orders.

FIG. 4B illustrates another diffractive element illuminated with non-normally incident light of a single wavelength channel diffracted into angularly separated diffraction orders.

FIG. 4C illustrates a first example of a wavelength-steering element receiving and directing light at different wavelength channels over a first dimension.

FIG. 4D illustrates a second example of a wavelength-steering element receiving and directing light at different wavelength channels over the first dimension.

FIG. 4E illustrates third example of a wavelength-steering element receiving and directing light at different wavelength channels over the first dimension.

FIG. 4F illustrates third example of a wavelength-steering element receiving and directing light at different wavelength channels over the first and a second dimension.

FIG. 4G illustrates a combination of the beam expansion optics of FIG. 3B and the wavelength-steering element of FIG. 4F.

FIGS. 4G-1 to 4G-4 illustrate embodiments of a bi-dimensional diffractive element.

FIG. 5A illustrates an example of a spectral comb filter.

FIG. 5B illustrates another arrangement of part of a system to facilitate estimation of the spatial profile of an environment.

FIG. 5C illustrates an embodiment of a beam director.

FIG. 6A illustrates an embodiment of a beam director.

FIG. 6B illustrates a graph of simulated results showing characteristics of an example reflection filter.

FIG. 6C illustrates an embodiment of a reflection filter and mirror combination.

FIG. 7 illustrates a simulated field of view resulting from an arrangement of optical beam director in accordance with the present disclosure.

FIG. 8 illustrates an angular placement of a diffractive element in a wavelength-steering element.

### DETAILED DESCRIPTION OF EMBODIMENTS

Described is a system for directing light into multiple directions, suited to light detection and ranging (LiDAR) applications to generate a three-dimensional image of a surrounding environment. “Light” hereinafter includes electromagnetic radiation having optical frequencies, including far-infrared radiation, infrared radiation, visible radiation and ultraviolet radiation. In general, LiDAR involves transmitting light into the environment and subsequently detecting the light reflected by the environment. By determining the time it takes for the light to make a round trip to and from, and hence the distance of, reflecting surfaces within a field of view, an estimation of the spatial profile of the environment may be formed. The present disclosure facilitates spatial profile estimation based on directing light over two substantially orthogonal dimensions.

The described system involves receiving light of controllable wavelength, such as that emitted from a wavelength-tunable laser, to control the direction of the light—a class of techniques hereinafter referred to as “wavelength-steering”. A diffractive element, such as a diffraction grating or a periodic structure, is an example of an optical element capable of wavelength-steering. In some embodiments two such diffractive elements may be used for optical beam direction over substantially orthogonal dimensions. For example, a first, non-rotating, diffractive element facilitates angular span over a first one of the two dimensions (hereinafter the “first dimension”) based on selected wavelength channel(s) of an optical beam. A second diffractive element rotating about a rotational axis parallel to its optic axis facilitates angular span over a second one of the two dimensions (hereinafter the “second dimension”) based on the rotation. However, there exists part of the rotation cycle of the rotating diffractive element where its diffraction axis becomes aligned (or approximately aligned) with that of the non-rotating diffractive element, thereby decreasing the diffraction efficiency for contributing to the angular span over the second dimension. The inventors recognise that such alignment (or approximate alignment) of the diffraction axes reduces the duty cycle of optical beam direction over the second dimension. It has been found that in some examples that the rotating diffractive element is effective in providing angular span in the second dimension only approximately 60% of the rotation cycle. Similarly, in other embodiments in which another wavelength dependent steering element is deployed to effect steering over the first dimension and a rotating diffractive element deployed to effect steering over the second dimension, there still exists part of the rotation cycle where there is decreased diffraction efficiency for contributing to the angular span over the second dimension. Examples of these other embodiments include embodiments in which the wavelength dependent steering element is a wavelength router, for instance in the form of an optical interleaver or demultiplexer.

Based on this recognition, the inventors have devised an arrangement of a beam director to increase the duty cycle of optical beam direction. Rather than using a single rotating diffractive element, multiple rotating diffractive elements with angularly offset diffraction axes are used to provide diffraction, hence angular span, over the second dimension throughout the rotation cycle, or at least with an increased duty cycle. The angular offset in the diffraction axes ensures that at least one of the rotating diffractive elements is out of alignment (or out of approximate alignment) with the non-rotating diffractive element at any part of the rotation cycle. In other words, the multiple rotating diffractive elements take turns to primarily diffract the optical beam along the second dimension. In one example, two co-rotating diffractive elements have their diffraction axes 90 degrees offset. In another example, three co-rotating diffractive elements have their diffraction axes 60 degrees offset.

### Examples of Spatial Profiling System

A spatial profiling system facilitated by the disclosed optical beam director may be useful in monitoring relative movements or changes in the environment. For example, in the field of autonomous vehicles (land, air, water, or space), the spatial profiling system can estimate from the vehicle's perspective a spatial profile of the traffic conditions, including the distance of any objects, such as an obstacle or a target ahead. As the vehicle moves, the spatial profile as viewed from the vehicle at another location may change and may be re-estimated. As another example, in the field of docking, the spatial profiling system can estimate from a container ship's perspective a spatial profile of the dock, such as the closeness of the container ship to particular parts of the dock, to facilitate successful docking without collision with any parts of the dock. As yet another example, in the field of line-of-sight communication, such as free-space optical or microwave communication, the spatial profiling system may be used for alignment purposes. Where the transceiver has moved or is moving, it may be continuously tracked so as to align the optical or microwave beam. As further examples, the applicable fields include, but are not limited to, industrial measurements and automation, site surveying, military, safety monitoring and surveillance, robotics and machine vision, printing, projectors, illumination, attacking and/or flooding and/or jamming other laser and IR vision systems.

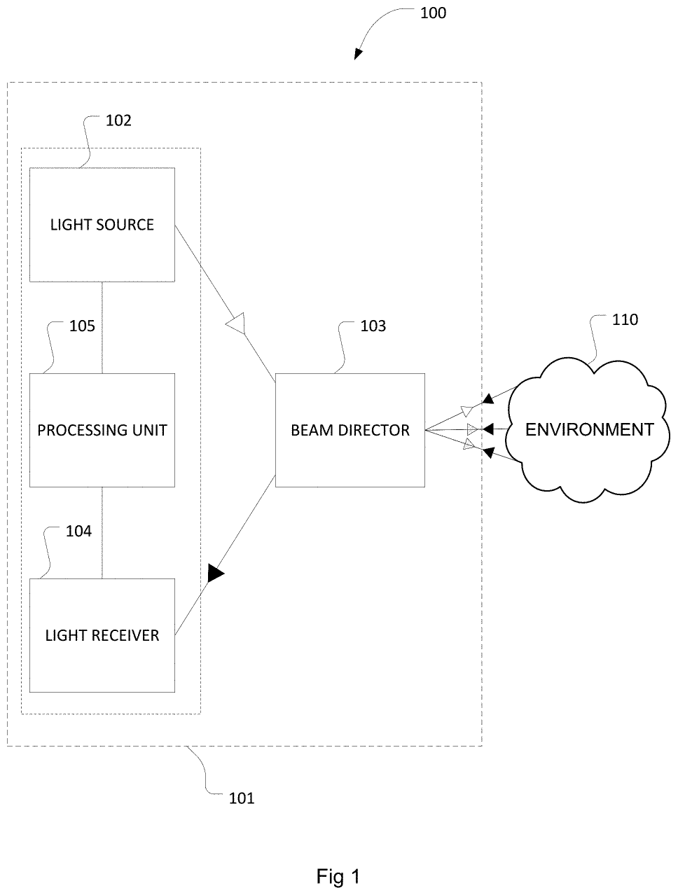

FIG. 1 illustrates an arrangement of a spatial profiling system 100. Further examples and details of a spatial profiling system are provided in PCT patent publication no. WO 2017/054036, the contents of which is incorporated herein. The system 100 includes a light source 102, a beam director 103, a light detector 104 and a processing unit 105. In the arrangement of FIG. 1, light from the light source 102 is directed by the beam director 103 in a direction in one or two dimensions into an environment 110 having a spatial profile. If the outgoing light hits an object or a reflecting surface, at least part of the outgoing light may be reflected (represented in solid arrows), e.g. scattered, by the object or reflecting surface back to the beam director 103 and received at the light detector 104. The processing unit 105 is operatively coupled to the light source 102 for controlling its operations. The processing unit 105 is also operatively coupled to the light detector 104 for determining the distance to the reflecting surface, by determining the round-trip time for the reflected light to return to the beam director 103.

In one variant, the light source 102, the beam director 103, the light detector 104 and the processing unit 105 are substantially collocated. For instance, in an autonomous vehicle application, the collocation allows these components to be compactly packaged within the confines of the vehicle or in a single housing. In another variant (not shown), the light source 102, the light detector 104 and the processing unit 105 are substantially collocated within a “central” unit, whereas the beam director 103 is remote from the central unit 101. In this variant, the central unit 101 is optically coupled to the remote beam director 103 via one or more optical fibres 106. This example allows the remote beam director 103, which may include only passive components (such as passive cross-dispersive optics), to be placed in more harsh environment, because it is less susceptible to external impairments such as heat, moisture, corrosion or physical damage. In yet another variant (not shown), a spatial profiling system may include a single central unit and multiple beam directors. Each of the multiple beam directors may be optically coupled to the central unit via respective optical fibres. The multiple beam directors may be placed at different locations and/or orientated with different fields of view (e.g. at the four corners of a vehicle). Unless specified otherwise, the description hereinafter refers to the collocation variant, but a skilled person would appreciate that with minor modifications the description hereinafter is also applicable to other variants.

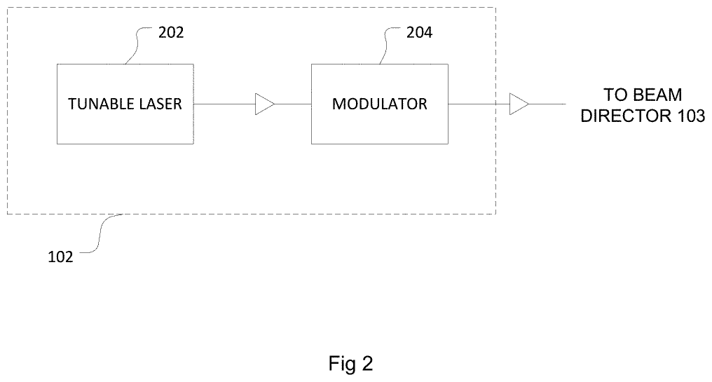

In one arrangement, the light source 102 is configured to provide the outgoing light having a time-varying intensity profile at a selected one of multiple wavelength channels (each represented by its respective centre wavelength λ₁, λ₂, . . . λ_{N}). FIG. 2 illustrates an example of one such arrangement of the light source 102. In this example, the light source 102 may include a wavelength-tunable light source, such as a wavelength-tunable laser diode, providing light of a tunable wavelength based on one or more electrical currents (e.g. the injection current into the into one of more wavelength tuning elements in the laser cavity) applied to the laser diode. In another example, the light source 102 may include a broadband light source and a tunable spectral filter to provide substantially continuous-wave (CW) light intensity at the selected wavelength.

In the example of FIG. 2, the light source 102 may include a modulator 204 for imparting a time-varying intensity profile on the outgoing light. In one example, the modulator 204 is a semiconductor optical amplifier (SOA) or a Mach Zehnder modulator integrated on the laser diode. The electrical current applied to the SOA may be varied over time to vary the amplification of the CW light produced by the laser over time, which in turn provide outgoing light with a time-varying intensity profile. In another example, the modulator 204 is an external modulator (such as a Mach Zehnder modulator or an external SOA modulator) to the laser diode. In yet another example, instead of including an integrated or external modulator, the light source 102 includes a laser having a gain medium into which an excitation electrical current is controllably injected for imparting a time-varying intensity profile on the outgoing light.

In another arrangement (not shown), instead of having a wavelength-tunable laser 202, the light source 206 includes a broadband laser followed by a wavelength-tunable filter. In yet another arrangement (not shown), the light source 206 includes multiple laser diodes, each wavelength-tunable over a respective range and whose respective outputs are combined to form a single output. The respective outputs may be combined using a wavelength combiner, such as an optical splitter or an AWG.

The light source 102 is configured to provide light at selected one or more of multiple wavelength channels. In one arrangement, the light source 102 provides a single selected wavelength channel at a time, such as a wavelength-tunable laser. In this arrangement, the described system 100 is capable of steering light in a particular direction based on one selected wavelength channel at a time. In another arrangement, the light source 102 provides a single or multiple selected wavelength channels, such as a broadband source followed by a tunable filter, the tunable pass band of which includes the single or multiple selected wavelength channels. Where one selected wavelength channel is used at a time, the light detector 104 may include an avalanche photodiode (APD) that detects any wavelength within the range of the multiple wavelength channels. Where multiple selected wavelength channels are used at a time, the light detector 104 may include a wavelength-sensitive detector system, such as using multiple APDs each dedicated to a specific wavelength channels, or using a single APD for multiple wavelength channels, each channel being distinguishably detectable based on their time-varying attribute (e.g. based on a different sinusoidal modulation such as a modulation frequency of 21 MHz, 22 MHz and 23 MHz . . . corresponding, respectively, to 1550.01, 1550.02 and 1550.03 nm . . . channels). The description hereinafter relates to light direction by providing a single selected wavelength channel at a time, but a skilled person would appreciate that, with minor modifications, the description is also applicable to light direction by providing multiple selected wavelength channels at a time.

The operation of the light source 102, such as both the wavelength-tunable laser 202 (e.g. its wavelength) and the modulator 204 (e.g. the modulating waveform), may be controlled by the processing unit 105.

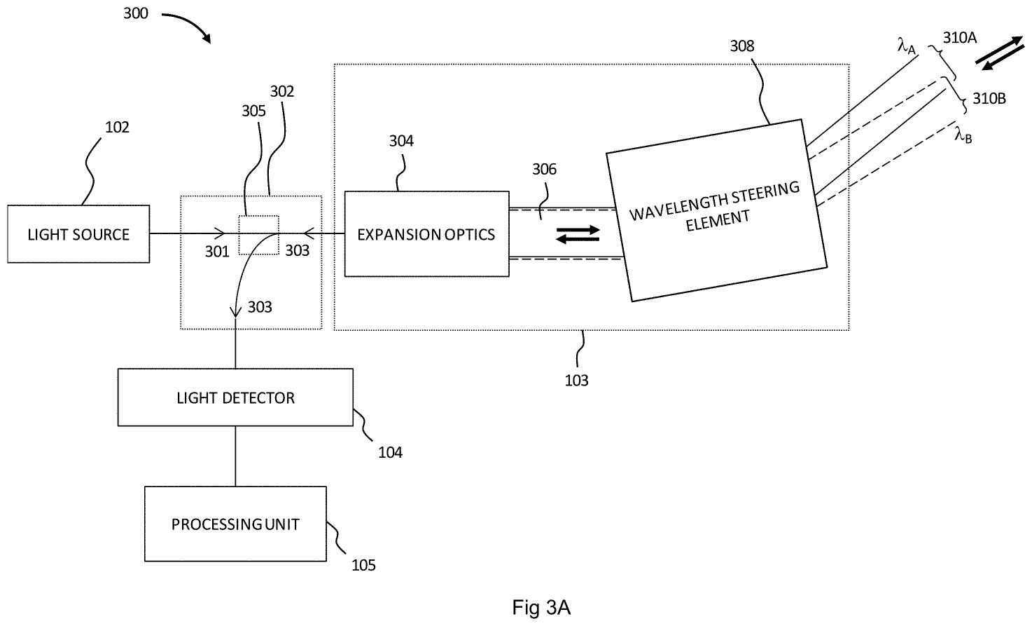

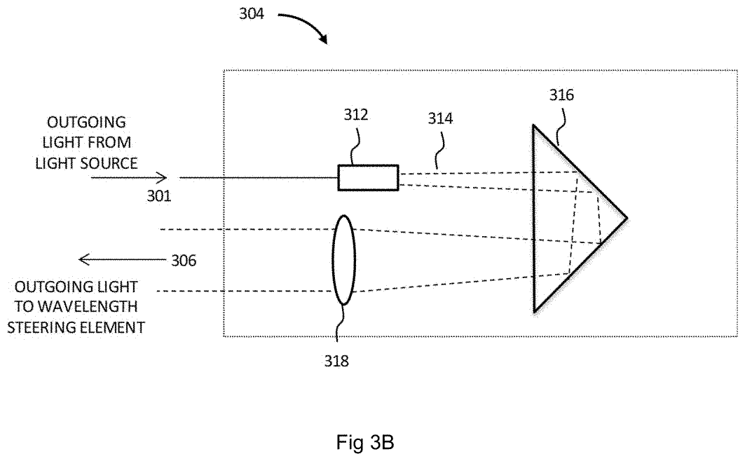

FIG. 3A illustrates an example 300 of the spatial profiling system in FIG. 1. In this example, the system 300 includes a light transport assembly 302 configured to transport the outgoing light 301 from the light source 102 to the beam director 103 and transport the reflected light 303 from the beam director 103 to the light detector 104. The light transport assembly 302 includes optical waveguides such as optical fibres or optical circuits (e.g. photonic integrated circuits) in the form of 2D or 3D waveguides. The outgoing light from the light source 102 is provided to the beam director 103 for directing into the environment. In some embodiments, any reflected light collected by the beam director 103 may additionally be directed to the light detector 104. In one arrangement, for light mixing detection, light from the light source 102 is also provided to the light detector 104 for optical processing purposes via a direct light path (not shown) from the light source 102 to the light detector 104. For example, the light from the light source 102 may first enter a sampler (e.g. a 90/10 guided-optic coupler), where a majority portion (e.g. 90%) of the light is provided to the beam director 103 and the remaining sample portion (e.g. 10%) of the light is provided to the light detector 104 via the direct path. In another example, the light from the light source 102 may first enter an input port of an optical switch and exit from one of two output ports, where one output port directs the light to the beam director 103 and the other output port re-directs the light to the light detector 104 at a time determined by the processing unit 105.

The light transport assembly 302 includes a three-port element 305 for coupling outgoing light received from a first port to a second port and coupling received from the second port to a third port. The three-port element may include an optical circulator or a 2×2 coupler (where a fourth port is not used). In one arrangement, the light transport assembly 302 includes an outbound guided-optic route between the light source 102 and the beam director 103 for carrying the outgoing light 301 at the first and second selected wavelength channels and an inbound guided-optic route 303 between the beam director 102 and the light detector 104 for carrying the reflected light 303 at the first and second selected wavelength channels (either at the same time or at different times). The guided-optic routes may each be one of a fibre-optic route and an optical circuit route.

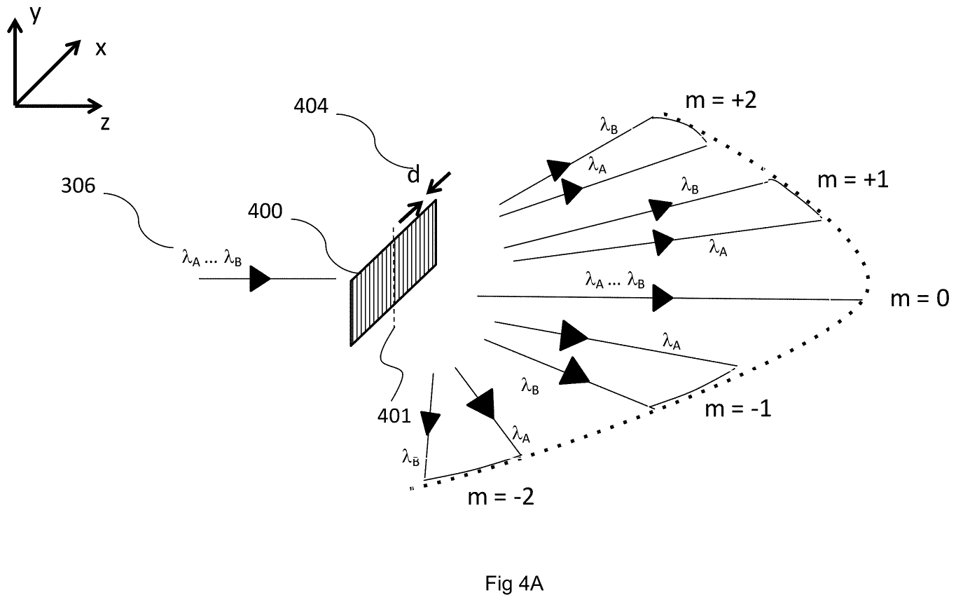

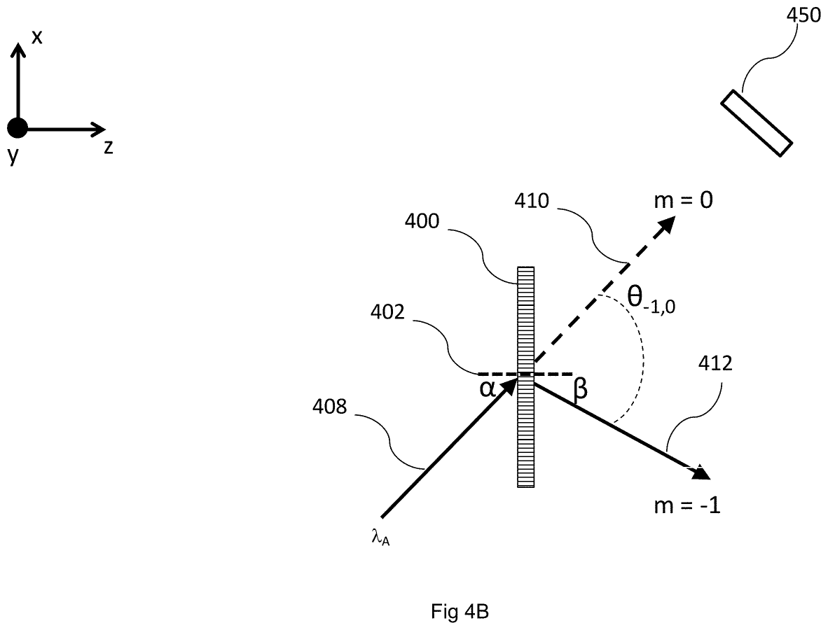

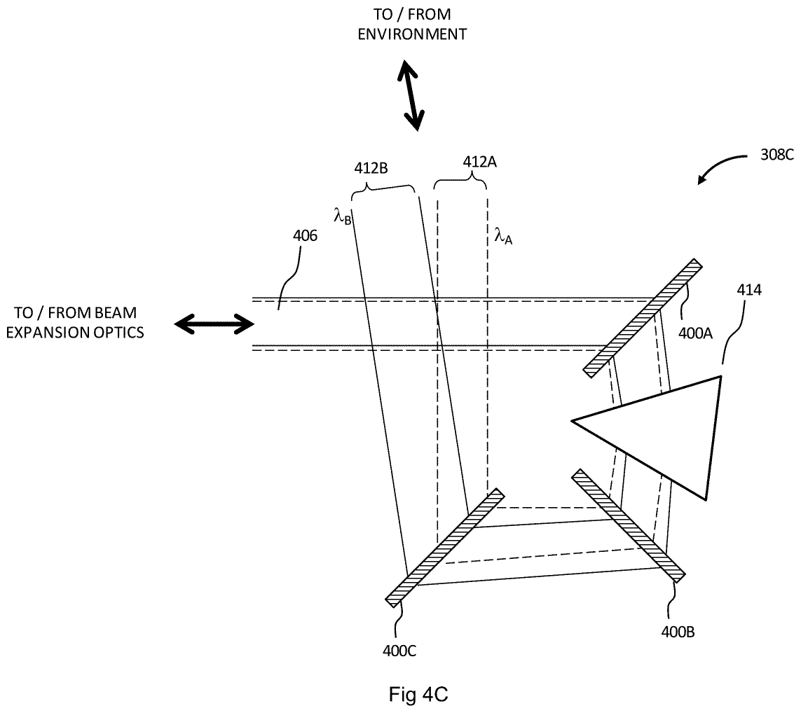

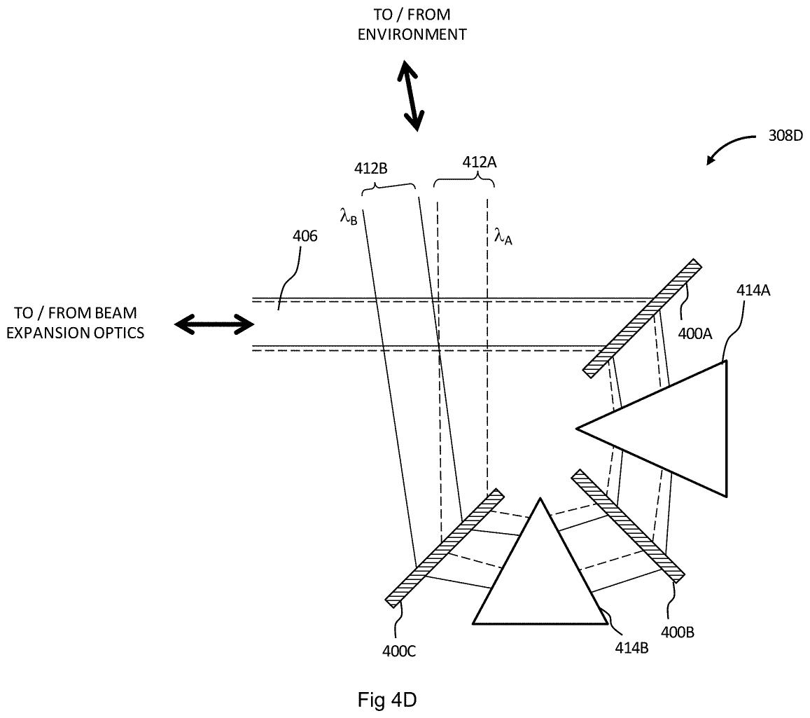

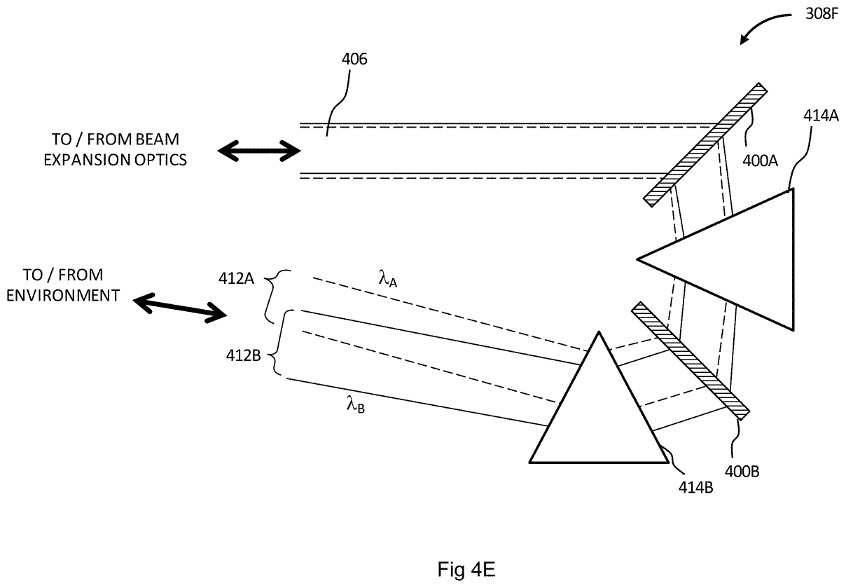

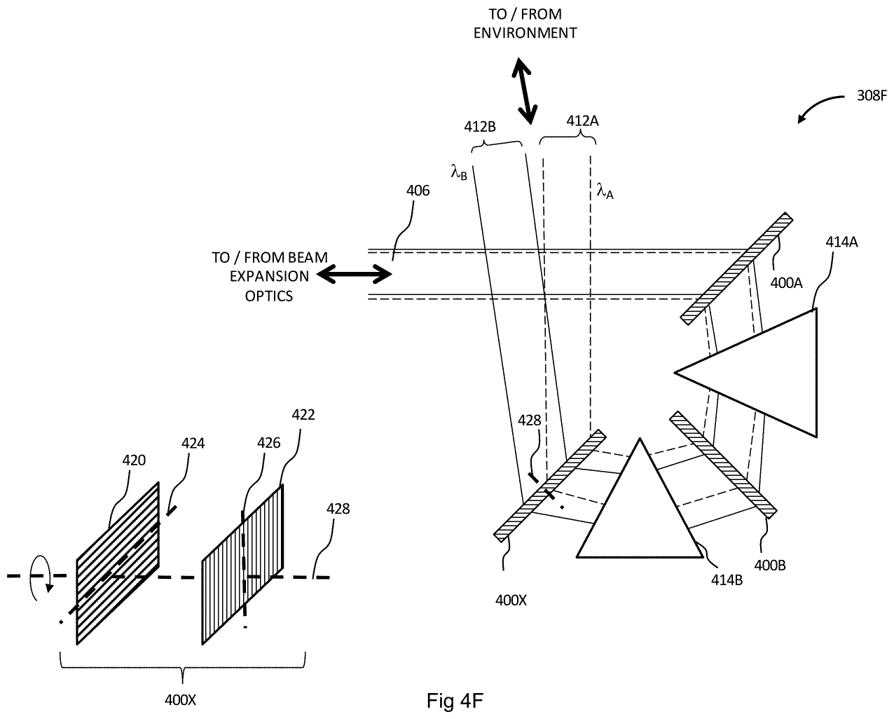

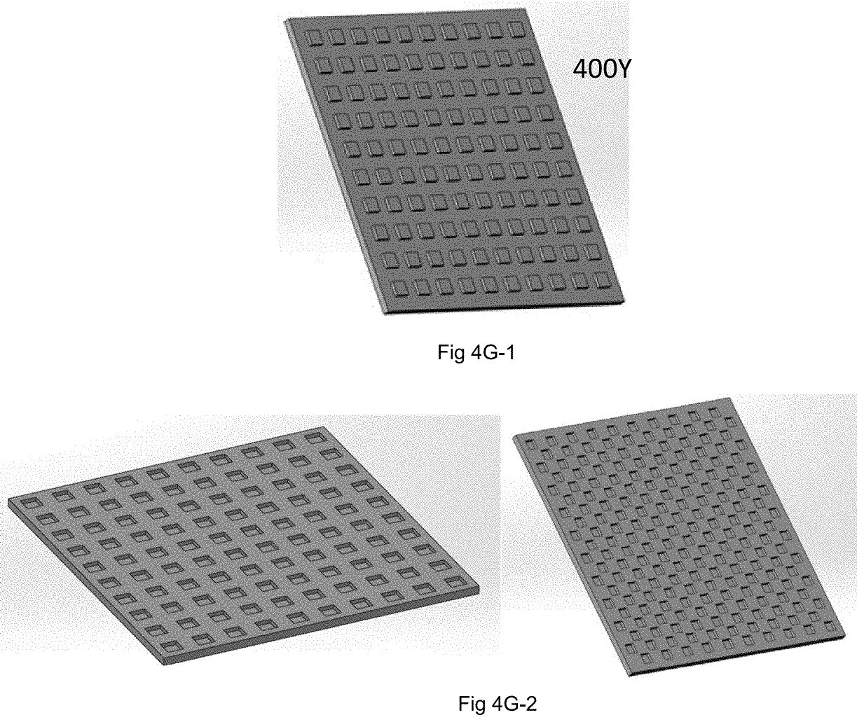

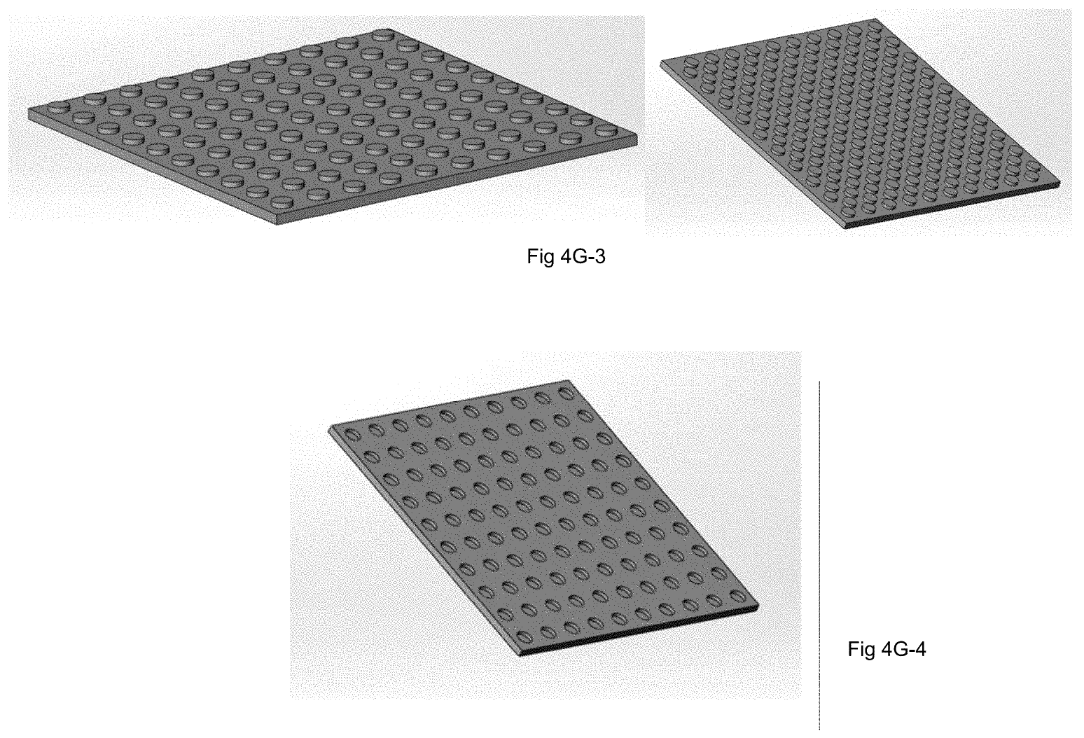

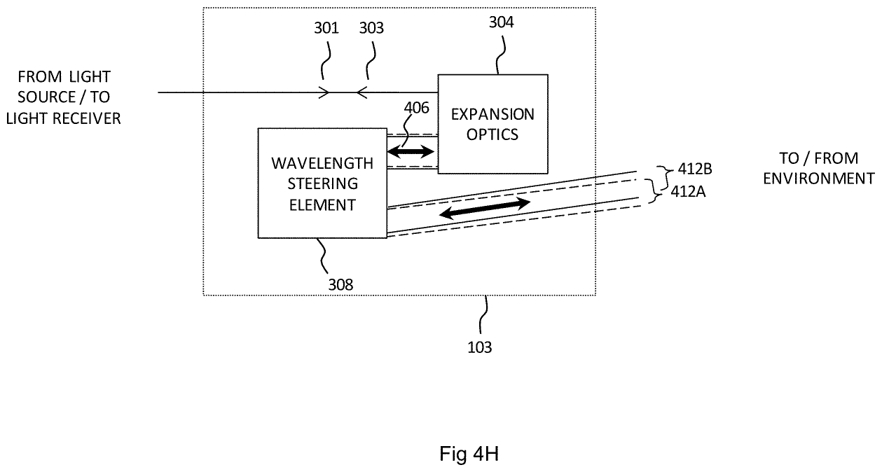

In one arrangement, as illustrated in FIG. 3A, the beam director 103 includes beam expansion optics 304. As illustrated in FIG. 3B, an example of the beam expansion optics 304 includes as a pigtailed collimator 312, such as a graded-index (GRIN) lens, to provide the outgoing light 301 from a wave-guided form into free-space form 314. The light in free-space form 314 continues to diverge in accordance with spatial diffraction optics. Where the light in free-space form 314 exhibits Gaussian intensity distribution, the light follows Gaussian diffractive optics. The beam expansion optics 304 further includes a retroreflector assembly 316 to receive and retro-reflect the light in free-space form 314 towards a focussing element 318. The retroreflector assembly 316 is adjustably placed based on the focal length of the focussing element 318 in order to focus the diverging beam 306 into an expanded collimated beam 306 towards the wavelength steering element 308. Use of the retroreflector assembly 316 reduces the footprint by folding an optical path while relaxing the optical alignment requirements. Further, use of the retroreflector assembly 316 provides angular tolerance to slight misalignment as a retroreflector is designed to parallelise an incoming optical beam with an outgoing optical beam. Referring back to FIG. 3A, the solid lines and the dashed lines represent expanded beams in different selected wavelength channels, and are illustrated to be slightly offset for illustrative purposes. In practice they may or may not overlap substantially or entirely in space. FIGS. 4D to 4G depicting solid and dashed lines are represented in a similar manner.

Beam Direction Over a First Dimension

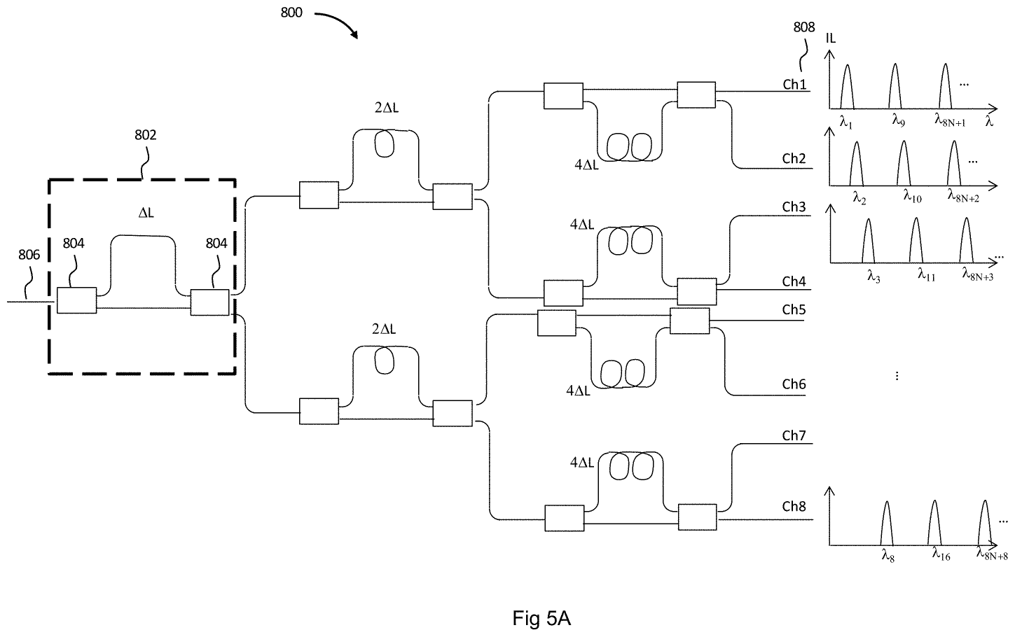

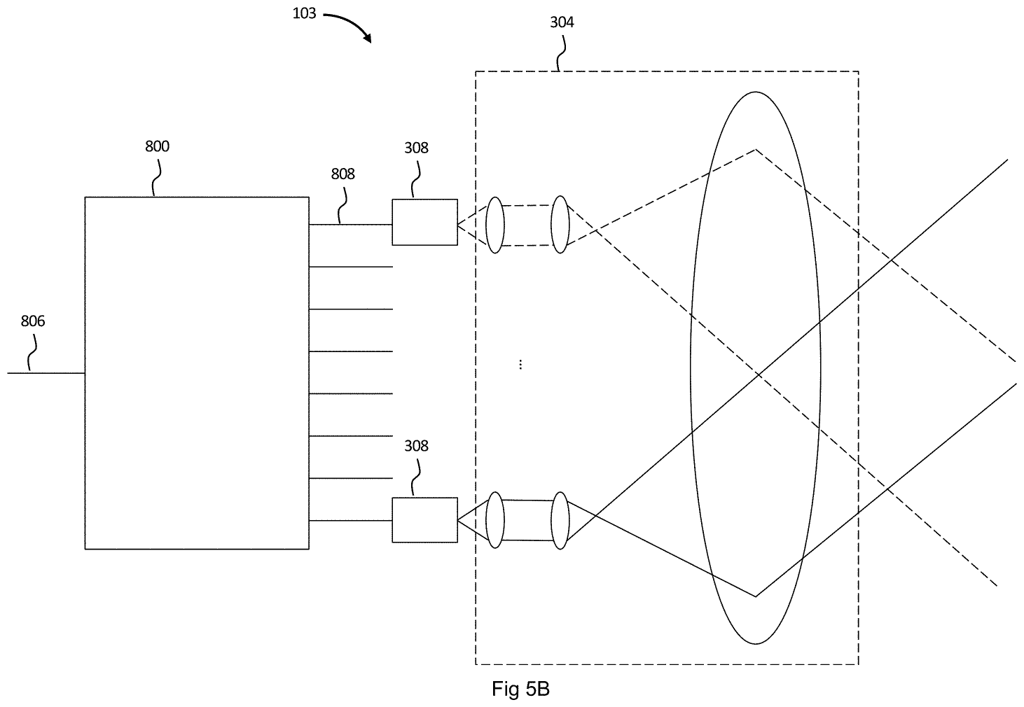

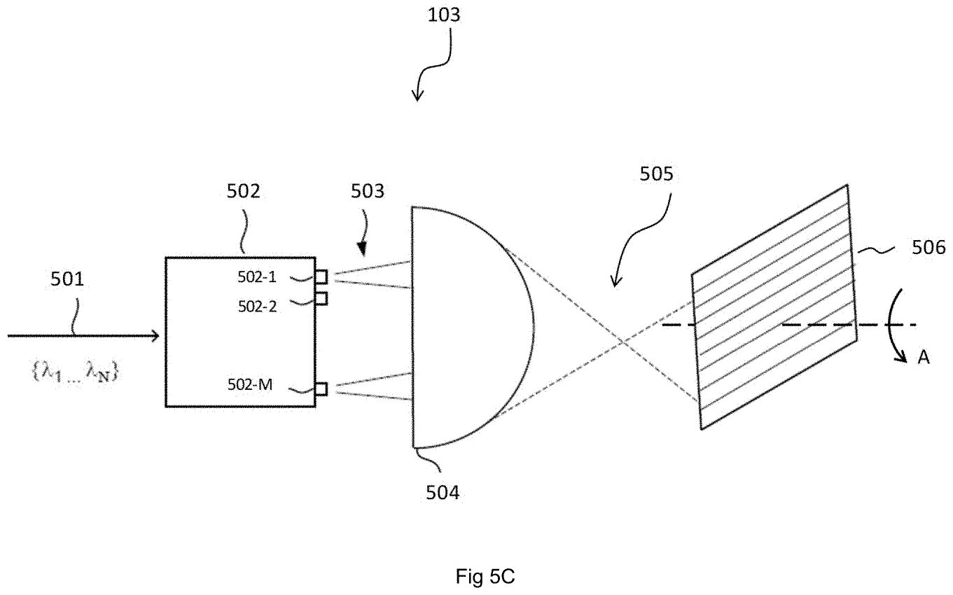

The beam director 103 further includes a wavelength-steering element 308 providing angular separation of light based on its wavelength. The wavelength-steering element 308 is configured to direct the expanded beam 306 into at least a first direction 310A and a second direction 310B along the first dimension, depending on the wavelength. While the wavelength-steering element 308 is schematically illustrated in the form of a block for simplicity, its actual form may differ and include at least a diffractive element, such as that illustrated in any of FIGS. 4A to 4E, or may include a wavelength router, such as that illustrated in FIG. 5A. In the case of a beam director that includes a wavelength router, the location of the transition to free space may be shifted to after the router, in which case the expansion optics 304 may be correspondingly positioned after the router. The first direction 310A corresponds to the outgoing light at a first selected wavelength channel λ_{A}. The second direction 310B corresponds to the outgoing light at a second selected wavelength channel λ_{B} of the same order.

Referring to FIGS. 4A and 4B, a diffractive element 400 having its diffraction axis 401 along the y-axis (e.g. defined by the direction of the grating lines as shown in FIG. 4A) and periodicity d 404 along the x-axis and being incident by light having a propagation component along the z-axis exhibits angular dispersion over the x-z plane. The angular dispersion is governed by:

mλ/d=sin(α)+sin(β) (Eq.1)

where α is the incident angle relative to z-axis, β is the diffraction angle relative to the z-axis, λ is the wavelength of the light, and m is the diffraction order. Each wavelength channel is centred at a centre wavelength (λ_{A} . . . λ_{B}) and occupies a relatively small spectral width, which is dependent on a number of factors such as modulation bandwidth and light source stability. For any given order m, the angular dispersion dβ/dλ=m sec(β)/d is tailorable by modifying the periodicity d. For example, the angular dispersion may be tailored to match the controllable wavelength range of the light to correspond with the desirable angular span of the wavelength-steering. In general, the smaller the periodicity d, the larger the angular dispersion dβ/dλ, thereby requiring a smaller wavelength range for a given angular span. This angular dispersion manifests as an intra-order angular separation of light of different wavelength channels for any non-zeroth order (i.e. m≠0).

FIG. 4A depicts a scenario of normal incidence (i.e. α=0) of light 306 containing multiple wavelength channels (λ_{A} . . . λ_{B}) diffracted into multiple diffraction orders m={+2, +1, 0, −1, −2}, whereas FIG. 4B depicts a scenario of non-normal incidence (i.e. α≠0 with reference to a normal incidence axis 402) of light 408 containing a single wavelength channel (λ_{A}) diffracted into multiple diffraction orders m={0, −1}, corresponding to angularly separated light beams 410 and 412. Hereinafter, diffractive element(s) are described in terms of diffraction gratings, but a skilled person would appreciate that any other optical elements capable of wavelength-dependent diffraction would be applicable. For example, in FIGS. 4A and 4B, the diffraction axis 401 is defined by the grating lines each extending along the y-axis and spaced apart by grating period d along the x-axis, with light incident on the grating surface extending in the x-y plane. For simplicity, FIGS. 4A and 4B both illustrate each light beam as a line without indicating its beam width. A skilled person would appreciate that in practice a light beam has a certain beam width.

FIG. 4C illustrates an example of a wavelength-steering element 308C including multiple diffraction elements 400A, 400B and 400C. While this example illustrates an example with three diffractive elements, a skilled person would appreciate that more (e.g. four) or fewer (e.g. two) diffractive elements may be used. Each additional diffractive element may provide additional diffraction, hence greater angular separation of the differently directed beams. The use of separate diffractive elements may also allow a greater number of degrees of freedom in designing the wavelength-steering element 308C (e.g. by relaxing anti-reflection coating requirements by selecting angles towards normal incidence rather than grazing incidence). However, each additional diffractive element may also increase attenuation (e.g. through a finite diffraction efficiency of the gratings). The diffractive elements 400A, 400B and 400C are configured to direct the expanded beam 406 into at least a first direction 412A and a second direction 412B along a first dimension, depending on the wavelength. The first direction 412A corresponds to the outgoing light at a first selected wavelength channel λ_{A}. The second direction 412B corresponds to the outgoing light at a first selected wavelength channel λ_{B}. FIG. 4C illustrates that each diffractive element produces one diffraction order but in practice each may produce one or more additional orders. At each diffractive element, the beam is incrementally angularly dispersed. The use of multiple diffractive elements increases the angular separation compared to an arrangement with, e.g. a single diffractive element. Further, the multiple diffractive elements are arranged to have their diffraction planes aligned to turn the light beam in the unidirectional beam path (e.g. clockwise as illustrated in FIG. 4C through gratings 400A, 400B and then 400C or anti-clockwise).

The unidirectional beam path facilitates folding of the optical path to reduce the size of the wavelength-steering element 308 and hence the overall system footprint. This path folding is addition to and in conjunction with the path-folding by the retroreflector 316. The cooperative path-folding by the retroreflector 316 and the wavelength-steering element provides space-saving advantages. For example, as illustrated in FIG. 4G, the combination of the retroflector 316 and the wavelength-steering element 308E facilitates a S-shaped optical path such that the input and output light through the beam director 103 remain on opposite sides.

FIGS. 4D and 4E illustrate other examples of a wavelength-steering element (308D and 308E). Each of the wavelength-steering elements in these other examples includes multiple diffractive elements and multiple dispersive elements. The wavelength-steering element 308D includes three diffractive elements 400A, 400B and 400C and two dispersive elements 414A and 414B. The wavelength-steering element 308E includes two diffractive elements 412A and 412B and two dispersive elements 414A and 414B. In these arrangements, the one or multiple dispersive elements intersperse with the one or more multiple diffractive elements for space-saving.

FIG. 5A illustrates an embodiment of a wavelength router, in particular a spectral comb filter in the form of an optical interleaver 800 for porting light between an input (composite) port and one of M output ports (interleaving ports), where M=2^{x} where x is a positive integer. In FIG. 5A, M is 8. In another arrangement, M may be 2 or 16. The optical interleaver 800 includes multiple interferometric segments (e.g. 802) each including splitters 804 at the respective ends of the segment separated by two interferometric paths having an optical path difference ΔL. Each segment 802 in a branch is divided into two segments in the next branch. The optical path difference doubles from one branch to the next (e.g. ΔL, 2ΔL, 4ΔL . . . etc). The composite port 806 is configured to receive or provide light at any one of every M-th consecutive wavelength channels (e.g. λ₁, λ_{M+1}, λ_{2M+1} . . . ) of the multiple wavelength channels. The M interleaving ports 808 are configured to respectively provide or respectively receive corresponding light at one of M groups of wavelength channels.

A skilled person would appreciate that, instead of or in addition to using the optical interleaver, other forms of a spectral comb filter, such as a Fabry-Perot resonators or a Mach-Zehnder interferometer, may be used, or other forms of wavelength router, such as using one or more arrayed waveguide gratings (AWGs), echelle demultiplexers or a combination of any of these components.

In another arrangement, instead of using an optical interleaver 800, one or array of reflective elements, such as microelectromechanical systems or MEMS, may be used to provide light direction over a dimension. The one or array of reflective elements may be configured to direct light towards expansion optics, for example the expansion optics 304, for collimation and expansion. This arrangement facilitates adjustment over continuous angles, rather than discrete angles as in the case for the optical interleaver 800.

In some embodiments the wavelength channels at the M ports of the wavelength router may be M groups of interleaved wavelength channels, for example as described in the incorporated related application PCT/AU2018/050961. In one example, where the N wavelength channels are designated by their centre wavelengths λ₁, λ₂, . . . λ_{N}, the M groups of interleaved wavelength channels are {λ₁, λ_{M+1}, . . . λ_{N-M+1}}, {λ₂, λ_{M+2} . . . λ_{N-M+2}}, . . . and {λ_{M}, λ_{2M}, . . . λ_{N}}. That is, in this example, each group include evenly spaced wavelengths channel (in this case, every M wavelength channels), and all M groups have the same spacing. In another example, the non-neighbouring wavelength channels may be non-interleaved wavelength channels, but still spread almost from λ₁ to λ_{N} (e.g. {λ₁, . . . λ_{N}}, {λ₂, . . . λ_{N-2}}, . . . and {λ_{M}, . . . λ_{N-M}}). In either example, each group of interleaved wavelength channels spreads almost from λ₁ to λ_{N}, the tunable range of the light source 102.

Accordingly, the wavelength router includes M second ports, corresponding to the M groups of wavelength channels, each second port carrying M/N non-neighbouring channels. In one case, one of M and N/M is at least 8, 16 or 32. This case corresponds to a beam director where light is directed across one of the first and second dimensions over at least 8, 16 or 32 pixels (e.g. generating 8, 16 or 32 dots across x or y axis in FIG. 2B). For example, in an hereinbefore described arrangement, M is 8. In another example, M is 16. In yet another example, M is 32.

An optical interleaver with a smaller free spectral range (FSR) carries more wavelength channels per second port. In one use case, the FSR is designed to be no more than 10 GHz. In another use case, the FSR is designed to be no more than 5 GHz. In yet another use case, the FSR is designed to be no more than 1 GHz. For example, in one arrangement, the FSR is 1 GHz.

Beam Direction Over a Second Dimension

In FIGS. 4C to 4E, all diffractive elements have their diffraction axes aligned in the same direction (e.g. along the y-axis) which causes angular dispersion in a first dimension (e.g. along the x-axis). By rotating or otherwise angularly adjusting at least one of the diffractive elements (e.g. about its optic axis or z-axis) and hence rotating its diffraction axis (e.g. in the x-y plane), the optical beam may be directed over a second dimension (e.g. along the y-axis), substantially perpendicular to the first dimension (e.g. along the x-axis). Further, to improve the duty cycle of diffraction along the second dimension, the at least one rotatable diffractive element is replaced by a diffractive assembly (hereinafter 400X) including multiple rotatable diffractive elements with angularly offset diffraction axes. The remaining non-rotating diffractive elements form another diffractive assembly for the first dimension, optically coupled to the diffractive assembly 400X for the second dimension. A skilled person would appreciate that the description herein referring to “rotation” or “rotating” includes any form of angular adjustment and not necessarily elements that are, for example, constantly or continuously rotating.

In one arrangement, as illustrated in FIG. 4F, the wavelength-steering element 308F is arranged similarly to the wavelength-steering element 308D, except that the diffractive element 400C is replaced by a diffractive assembly 400X including two diffractive elements 420 and 422 with angularly offset diffraction axes 424 and 426. The two diffractive elements 420 and 422 are configured to co-rotate (i.e. at the same rate and same rotational direction) about a common rotational axis 428 perpendicular to the diffraction axes 424 and 426. The angular offset allows the diffractive elements 420 and 422 to sequentially diffract light over the second dimension. In this arrangement, the diffraction axes 424 and 426 are maximally angularly offset from each other (i.e. by 90 degrees in the illustrated case of two diffractive elements). By maximising the angular offset between the diffraction axes, the sequential diffraction maximises the duty cycle of diffraction over the second dimension, so that at least one of the diffractive element of the diffractive assembly 400X provides sufficient angular dispersion, such as beyond a diffraction threshold, while the other diffractive element provides little or none. Further, the periodicity d may be optimised to maximise the duty cycle of diffraction beyond the diffraction threshold along the second dimension. It has been found that the use of multiple diffractive elements with maximally angularly offset diffraction axes may increase the duty cycle of optical beam direction for the second dimension from about 60% to close to 100%, so as to reduce any gaps in the sequential diffraction where the directed light drops below a diffraction threshold. The diffraction threshold may correspond to a specific diffraction condition(s). In one arrangement, the diffraction threshold corresponds to a non-diffracting condition, such as at a portion(s) of the rotation cycle where Eq. 1 has no solution, hence achieving no diffraction. In another arrangement, the diffraction threshold corresponds to a minimum set of metrics, such as one or more of (a) a minimum required angular span and/or (b) a minimum required output optical power or grating transmission. For example, the diffraction threshold corresponds to light being directed with output optical power to detect a range over 200 meters in the field of view of +/−60 degrees in the horizontal axis and +/−15 degrees in the vertical axis. The diffraction threshold defines the duty cycle to be the fraction of operational time that the spatial profiling system is performing within the above specifications.

A skilled person would appreciate that the diffraction axes may be less than maximally angularly offset (e.g. by 85, 80 or 75 degrees in the illustrated case of two diffractive elements) to maintain sufficient diffraction during the rotation cycle. Further, a skilled person would appreciate that the multiple diffractive elements 420 and 422 may, instead of co-rotating about a common rotational axis 428, rotate independently of each other about its own rotational axis. In other arrangements (not shown), the diffractive assembly 400X may include more than two diffractive elements, such as three diffractive elements, in which case the maximally angular offset from one another is 60 degrees.

In another arrangement, the diffractive element 400C or diffractive assembly 400X may be replaced by a 2D single diffractive element 400Y, for example, a 2D grating as illustrated in FIG. 4G-1. Unlike a conventional 1D diffraction grating where a “lines-like” pattern is repeated periodically along one direction, a designed bi-dimensional profile is created for the 2D grating 400Y where periodicity is repeated across two dimensions.

The bi-dimensional profile creates a plurality of diffraction axes within a single grating, as opposed to the single diffraction axis of a 1D diffraction grating.

In some embodiments the designed bi-dimensional profile is selected to increase or maximise the duty cycle and/or increase or maximise efficiency of the grating over a range of angles. The efficiency to be maximised may be for the first diffraction order, either alone or in combination with minimisation of one or more of the other diffraction orders. The range of angles within the active duty cycle may correspond to the angular range of movement of the grating within the spatial profiling system. In some embodiments the range of angles approaches 360 degrees, for example in embodiments where the grating rotates by spinning clockwise or anticlockwise (including spinning in one direction and then the other) about its rotation axis. In other embodiments the range of angles is less than 360 degrees.

In some embodiments the rotation axis may be either orthogonal to the grating's surface. In other embodiments the rotation axis may be off-set from a line orthogonal to the grating's surface, in which case the grating will wobble while spinning.

The range of angles for which the desired diffraction order is efficiency optimised may omit one or more sub-ranges. In some embodiments optimisation excludes the diagonals. For example, the profile may be optimised for an angular range of −40 to +40, and +50 to +130, and +140 to +220 and +230 to +310 degrees at the same time. Excluding the diagonals may have application to grating profiles in the form of 2-dimensional arrays, formed into rows and columns. The excluded diagonals or other sub-ranges, if provided, may be narrower or wider than +/−10 degrees, for example +/−1 through to +/−20 degrees or any value in between.

In some embodiments the designed bi-dimensional profile may recreate or approximate the diffraction of two conventional gratings rotationally offset from each other, as for example the diffractive assembly 400X. In one example, the designed bi-dimensional profile may be a 2D periodic sequence of pillars having squared cross section as illustrated in FIG. 4G-1. In other examples, different topologies and various cross section shapes of the periodic 2D pattern may be implemented, for example as illustrated in FIG. 4G-2 (two topologies with periodic holes having square cross section), FIG. 4G-3 (two topologies with periodic pillars having circular cross section), and FIG. 4G-4 (periodic holes having circular cross section).

The fabrication procedure of the 2D grating may be similar as for a conventional diffraction grating. In one example, on a substrate of dielectric material, such as fused silica, may be deposited several layers of materials characterised by different refractive index to create the desired change in refractive index at the surface interface. The optimisation of the number and thickness of layers may vary and relate to wavelength range, angles of incidence and desired diffraction modes of the light.

The designed pattern may be etched on one of the surfaces of the dielectric substrate. In other embodiments the pattern may be formed by deposition (or any other suitable technique) on both surfaces.

A skilled person would appreciate that the design of the pattern may be optimised through thickness, position and cross section sizes of the pillars/holes. A person skilled in the art would also appreciate that the substrate may be either transmissive or reflective material and the grating would accordingly transmit or reflect the diffracted light beams respectively.

In some embodiments of a transmission diffractive grating, an anti-reflection (AR) coating is provided on either one or both of the surfaces of the 2D grating. For example when the designed pattern is on one side of the diffraction grating, for example by deposition and etching, the AR coating may be on the other side of the substrate surface. In some embodiments the AR coating is already present on one surface of the substrate before deposition and/or etching of the pattern.

While the arrangements described above with reference to FIGS. 4G-1 to 4G-4 relate to rectangular arrays, in other embodiments different 2D profiles are adopted. For example, in some embodiments the profile is in the form of a polar array. In addition, the geometric shape of the substrate, which has been depicted as square or rectangular in the example, can be different. For example in some embodiments the substrate is in the shape of a disc.

FIG. 5B illustrates an example beam director 103 including the optical interleaver 800, N wavelength steering elements 308 and expansion optics 304. The wavelength steering elements 308 each receive light from respective interleaving ports that are spatially offset over the first dimension. The wavelength steering elements 308 each direct the light over the second dimension (e.g. into and out of the page), whereas the expansion optics 304 angles the directed light from the beam directors 103 to be further directed over the first dimension (e.g. up and down the page). The wavelength steering elements 308 may each include on or more diffractive elements, for example as described with reference to any of FIGS. 4A to 4F. In some embodiments the one or more diffractive elements includes a rotating diffractive element as described herein. In some embodiments the rotating diffractive element is a diffractive assembly 400X including two diffractive elements 420 and 422 with angularly offset diffraction axes 424 and 426, as described above.

FIG. 5C illustrates another embodiment of the beam director 103 of FIG. 1. Light 501 from the light source 102 includes, for example, a selected one of N wavelength channels. The light source 102 may be a wavelength-tunable laser, allowing selection of the desired wavelength channel via an electronic control signal.

As illustrated in FIG. 5C, the beam director 103 includes a wavelength router 502 (e.g. an optical interleaver or demultiplexer), which may be or operate similarly to any embodiment of wavelength router described herein. In this embodiment the wavelength router 502 outputs light to free space, for example emitting light from output ports 502-1 to 502-M, located along an edge or along a surface of the wavelength router 502. The output ports of 502 are physically arranged to direct the routed light across a first dimension. For example light may be routed along a first axis, which may for example be the vertical direction.

The expanding light 503 from the output ports is received by a collimating element disposed across the wavelength dimension. For example if the wavelength dimension is a vertical axis, a collimating lens 504 may be disposed across the vertical axis. The collimating lens 504 receives the expanding light and produces corresponding collimated light 505.

The collimated light 505 from the collimating lens 504 is received by a diffracting element, for example a rotating grating 506. In other embodiments on optical sub-system including more than one grating may receive the collimated light 505, for example any of the arrangements as described with reference to FIGS. 4A to 4F. The grating or optical sub-system is configured to steer the received collimated light 505 across the second dimension. In the case of an optical sub-system, the steering across the first dimension may also be increased by one or more components of the optical sub-system. For example, the optical subsystem of FIG. 4F with a rotating grating has an ability to steer across both the first and second dimensions. Referring to FIG. 5C, rotation of the grating 506 in direction A may cause light to be steered across the second dimension, the light having been steered across first dimension by the wavelength router 502. In some embodiments beam expansion optics are also included, similar to beam expansion optics 304, for example to increase the steering range across the first dimension.

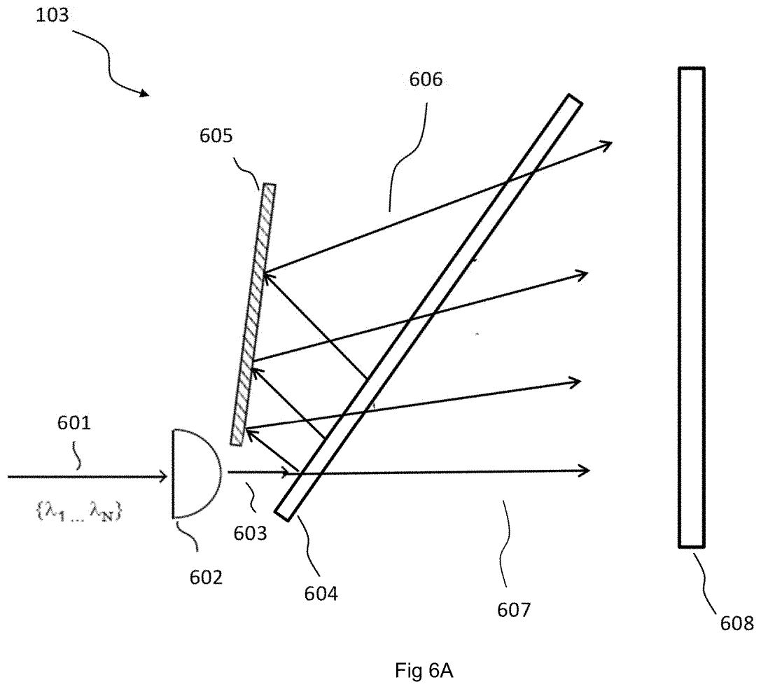

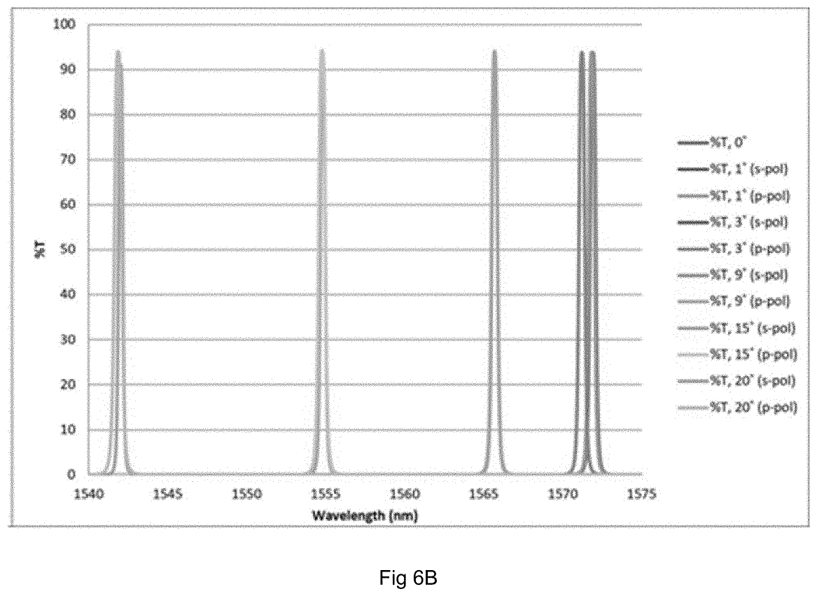

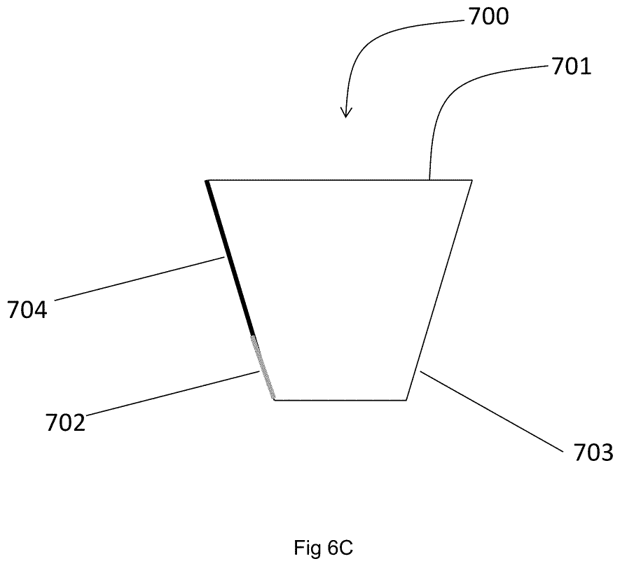

FIG. 6A illustrates another embodiment of the beam director 103 of FIG. 1. The light 601 from the light source 102 includes, for example, a selected one of N wavelength channels. As with the preceding example embodiments, the light source 102 may be a wavelength-tunable laser, allowing selection of the desired wavelength channel via an electronic control signal.

The light 601 is received by a collimating lens 602 optically coupled to or part of the beam director 103, to produce collimated light 603. The collimated light 603 is received by a filter element, for example a wavelength and/or angle dependent optical filter, for example a thin film reflection filter 604.

Reflected light from the reflection filter 604 is received by a mirror 605, which returns light to the reflection filter 604. In some embodiments, the reflection filter 604 is angle dependent and is arranged relative to the mirror 605 so that the return light 606 is received by the reflection filter 604 at a different angle to the collimated light 603. In one arrangement, the mirror 605 is arranged to diverge from the reflection filter 604. The angle of divergence may be about 5 degrees, about 10 degrees or about 20 degrees or any value in between. The different wavelengths passed by the reflection filter 604 are at different angles, creating a solidstate field of view. The resolution of the output is a function of the bandpass range of the filter (in the example discussed with reference to FIG. 6A it is 0.45 nm) and the angle of the bandpass filter relative to the mirror.

FIG. 6B is a graph of simulated results showing characteristics of an example reflection filter, which may be suited for use as the reflection filter 604 of FIG. 6A. As can be seen from this graph at least 15 degrees field of view is possible over the C-band simulated from this information.

FIG. 6C illustrates another embodiment of a reflection filter and mirror combination, in the form of a bandpass filter wedge 700. The bandpass filter wedge 700 includes a wedge-shaped body 701 of optically transparent or substantially optically transparent material. The body 701 includes an entrance area 702, which may be coated with an anti-reflection coating. Light from the light source 102 enters the bandpass filter wedge 700 at the entrance area 702. A bandpass filter 703 is provided along one side of the wedge, for example by microstructure deposition, in this example opposite the entrance area 702. The bandpass filter 703 has the same or similar properties to the reflection filter 604 discussed above, passing different wavelengths dependent on the incident angle of light onto the filter. A mirror 704, for example a mirror coating, is provided on the other side of the wedge to the bandpass filter 703.

In alternative embodiments, the reflection filter 604 or bandpass filter 703 is an array of filters, whereby adjacent filters pass different wavelengths. In these alternative embodiments, the incident angle may or may not change with each reflection between the filter and the mirror.

Light 607 that has been steered by the optical filters across the first dimension may be received by another steering element, to steer the light across the second dimension. For example the light 607 may be received by a rotating grating 608. The rotating grating 608 may operate in a similar manner to the rotating grating 506 described with reference to FIG. 5C.

In some embodiments, control of rotation of the rotating grating is by the processing unit 105 of FIG. 1. The processing unit 105 provides a control signal to a motor or micromotor, for example a d micromotor (not shown). The processing unit 105 therefore operates as a motor controller. In some embodiments the control is simply ON or OFF, that is the rotating grating is caused to rotate or not. In other embodiments, the speed of rotation is also controlled between two or different selectable modes with different associated speeds of rotation. It will be appreciated that the functions of the processing unit 105 may be performed by computer hardware that is either centralised at a processing device or distributed across multiple processing devices, with appropriate communication between the devices.

In some embodiments the rotational position of the rotating grating is measured or otherwise monitored by a position sensor. In one example an encoded optical disc rotates with the grating and is measured by the sensor, which is an optical sensor, to provide a signal indicative of the rotational positon of the grating. In another example a magnetic or electromagnetic element rotates with the grating and the sensor is a Hall effect sensor, which generates a signal indicative of the rotational position of the grating. In another example a sensor measures the intensity of the zero order light through the grating, which is correlated to the rotational position of the grating. Referring for example, to FIG. 4B, an optical intensity sensor 450 may be positioned along the path m=0. In another example, the grating includes one or more fiducial markers (e.g. markings on the grating, grating pattern, a magnetic element disposed on or in the grating etc), detectable by the sensor. The signal is then communicated to the processing unit 105, which bases its processing in part on the signal. For example, the processing unit 105 (or other computational system) may be pre-programmed with or otherwise have access to information that correlates values of the signal with angular diversion of light from the system, enabling a spatial profile to be constructed, either by the processing unit 105 or by another computational system that receives the relevant data, for example from the processing unit 105.

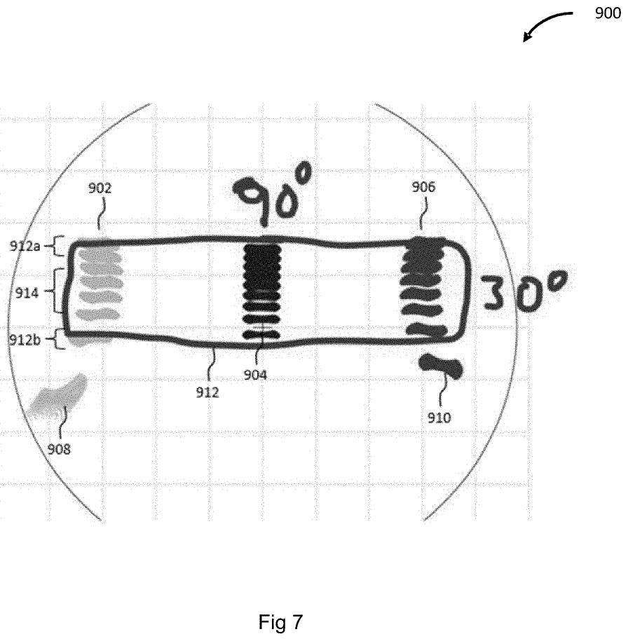

In one arrangement, the angular span along the first dimension based on wavelength channel selection is approximately 30 degrees, whereas the angular span along the second dimension based on rotation of the diffractive assembly 400X is approximately 90 degrees. FIG. 7 illustrates a simulated field of view 900 resulting from steering an input optical beam by an arrangement of optical beam director in accordance with the present disclosure. The field of view in FIG. 7 is made up of individual points, each of which represents a direction in which the input optical beam is steered. The points are so fine that they appear in FIG. 7 to be continuous patches. The different groups 902, 904 and 906 of points represent different ranges of grating rotation angles. For example, the groups 902 and 906 each represent grating rotation angles resulting in optical beam direction near either limit of the horizontal field of view (i.e. over the second dimension), whereas the group 904 represents grating rotation angles resulting in optical beam direction near the centre of the horizontal field of view (i.e. over the second dimension), and within each group, the individual point represents individual wavelength channels that make up the vertical field of view (i.e. over the first dimension). A substantially rectangular outline 912 indicates a substantially rectangular field of view. Further, the outline 912 also loosely marks the wavelength channels and grating rotating angles that satisfy the diffraction threshold. Outside the outline 912 are groups 908 and 910 which do not satisfy the diffraction threshold.

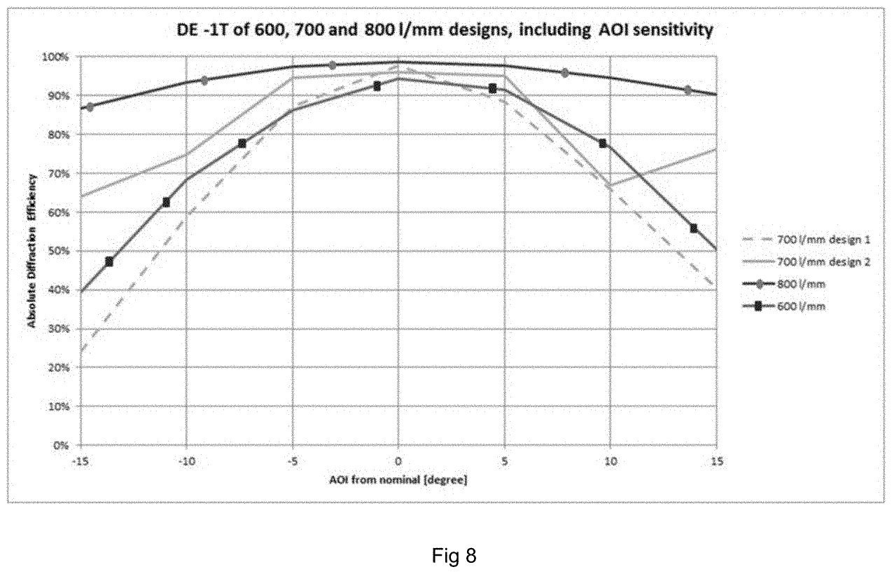

The most efficient diffraction (measured by transmission) for a diffraction grating occurs when the incident angle equals the Littrow angle. As the incident angle deviates from this angle (e.g. due to beam direction over the first dimension and/or rotation of the diffractive assembly), the diffraction efficiency decreases. FIG. 8 illustrates the diffraction efficiency of one arrangement at various versus incident angle between +/−15 degrees (relative to the Littrow angle) of angular span along the first dimension. The “edge” wavelength channels (i.e. wavelength channels corresponding to the limits of the angular span along the first dimension at around −15 degrees to around +15 degrees) tend to suffer more than the non-edge wavelength channels in terms of diffraction efficiency, and hence range. To improve diffraction efficiency for edge wavelength channels, the periodicity d of the diffractive elements may be adjusted. The periodicity d may be optimised to maximise diffraction efficiency, and hence range. For example, FIG. 8 illustrates improvements in diffraction efficiency from around 30-40% to around 80 to 90% at edge wavelength channels when increasing the periodicity d from 600 lines/mm to 800 lines/mm.

Now that arrangements of the present disclosure are described, it should be apparent to the skilled person in the art that at least one of the described arrangements have one or more of the following advantages:
The duty cycle of diffraction is improved by utilising multiple rotating dispersive elements with angularly offset diffraction axes.
The increased duty cycle reduces warping of bowing of the field of view.
Reduced fabrication costs.
Facilitated mounting and alignment process. Reduced risk of breaking or damaging the grating.
   It will be understood that the invention disclosed and defined in this specification extends to all alternative combinations of two or more of the individual features mentioned or evident from the text or drawings. All of these different combinations constitute various alternative aspects of the invention.

1. An optical beam director including:
a first diffractive assembly arranged to direct an optical beam towards one or more of multiple directions over a first dimension based on respective one or more selected wavelength channels of the optical beam; and
a second diffractive assembly including a plurality of diffractive elements, each of the diffractive elements being:
oriented with its diffraction axis angularly offset from at least one other diffractive element's diffraction axis; and
rotatable about a rotational axis perpendicular to its diffraction axis to facilitate directing the optical beam over a second dimension substantially orthogonal to the first dimension.

2. The optical beam director of claim 1 wherein the plurality of diffractive elements are co-rotatable about a common rotational axis.

3. The optical beam director of claim 1 wherein the plurality of diffractive elements are oriented with their diffraction axes maximally angularly offset.

4. The optical beam director of claim 3 wherein the plurality of diffractive elements includes two diffractive elements with their diffraction axes angularly offset by 90 degrees from each other.

5. The optical beam director of claim 3 wherein the plurality of diffractive elements includes three diffractive elements with their diffraction axes angularly offset by 60 degrees from one another.

6-10. (canceled)

11. The optical beam director of claim 1 wherein the first diffractive assembly includes one or more additional diffractive elements being non-rotatable about its (their) optic axis(es) to facilitate directing the optical beam over the first dimension.

12. The optical beam director of claim 1, wherein over a field of view across the first and second dimensions, the second diffractive assembly has a duty cycle of at least 80%.

13. An optical system including:
optical components arranged to direct light comprising multiple wavelengths in one or more optical beams into an environment having a depth dimension over a first dimension and a second dimension, the second dimension substantially perpendicular to the first dimension, the optical components including:
a first optical subsystem to receive the light, the first optical subsystem comprising a plurality of elements selected from dispersive, diffractive and reflective elements, the plurality of elements arranged in a configuration that directs the received light over the first dimension based on wavelength; and
a second optical subsystem for receiving the light directed over the first dimension, the second optical subsystem comprising a plurality of angularly offset diffraction axes that are each rotatable about a rotational axis perpendicular to its diffraction axis to facilitate directing the optical beam over the second dimension; and
a receiver for light returned from the environment responsive to light from the optical components, the returned light containing information for determination of the depth dimension over the first dimension and the second dimension.

14. The optical system of claim 13, wherein each of the plurality of elements in the first optical subsystem are substantially fixed in location and orientation relative to each other.

15. The optical system of claim 13, wherein the first optical subsystem comprises an angle dependent bandpass filter, wherein one wavelength channel is reflected and another adjacent wavelength channel is passed, creating angular discrimination between the channels.

16. The optical system of claim 15, wherein the first optical subsystem is arranged so that at least a portion of the received light is directed onto the angle dependent bandpass filter a plurality of times, at different angles corresponding to different pass-bands of the angle dependent bandpass filter.

17. The optical system of claim 16, wherein the arrangement of the first optical subsystem includes a mirror facing the angle dependent bandpass filter at an orientation other than parallel.

18. The optical system of claim 13, wherein the second optical subsystem includes a plurality of diffractive elements, including:
a first diffractive element rotatable through a first set of positions that effect diffraction above a threshold related to directing the optical beam over the second dimension, and a second set of positions that do not effect diffraction above the threshold; and
a second diffractive element that is oriented within the optical system, at least when the first diffractive element is in a position of the second set of positions, to effect diffraction above the threshold.

19. The optical system of claim 18, configured to synchronously rotate the first and second diffractive elements.

20. The optical system of claim 19, configured to rotate the first and second diffractive elements about substantially the same axis of rotation.

21. The optical system of claim 13, wherein the second optical subsystem includes a transmissive or reflective bi-dimensional profile grating.

22. (canceled)

23. (canceled)

24. The optical system of claim 21, wherein the transmissive or reflective bi-dimensional profile grating comprises discrete diffracting elements distributed across the transmissive or reflective bi-dimensional profile grating, the discrete diffracting elements distributed periodically across a first dimension and across a second dimension different from and angularly offset from the first dimension.

25-32. (canceled)

33. An optical beam director including a diffractive element characterised by a two-dimensional pattern on a substrate, the two-dimensional pattern providing the diffractive element with a plurality of angularly offset diffraction axes, wherein the substrate of the diffractive element is rotatable about a rotational axis to facilitate directing an optical beam.

34. The optical beam director of claim 33, including a plurality of optical beam directors, a first optical beam director that facilitates directing the optical beam over a first dimension and includes the diffractive element characterised by the two-dimensional pattern on the substrate and a second optical beam director arranged to direct the optical beam towards one or more of multiple directions over a second dimension, substantially orthogonal to the first dimension.

35. The optical beam director of claim 33 wherein the diffraction axes are maximally angularly offset.
